(19) United States
(12) Patent Application Publication
(10) Pub. No.: US 2009/0313600 A1
(43) Pub. Date: Dec. 17, 2009

(54) CONCURRENT CODE GENERATION

(75) Inventors: Andrew Ayers, Kirkland, WA (US); John Lin, Issaquah, WA (US); Patrick Sathyanathan, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/138,440

(22) Filed: Jun. 13, 2008

(51) Int. Cl. G06F 9/44

(52) U.S. Cl. 717/106

(57) ABSTRACT

A system and method for performing multi-threaded compilation of source code is provided. A representation such as a directed acyclic graph (DAG) may be generated representing functions and their dependency relationships on each other. Code is generated and optimized for each function. The code generation is scheduled, based on the representation, so that multiple functions may be compiled concurrently, while enforcing ordering restrictions to generate code in a deterministic manner. An application executable may be generated that is deterministic, based on the input source code and regardless of variations due to multi-threading.

### TECHNICAL FIELD

The present invention relates generally to program compilers, and, more particularly, to multi-threaded compilation of computer programs.

### BACKGROUND

A compiler is a computer program that translates a source code language into a target language. Typically, though not always, the source code is written in a high level language and the target language is a low level object code.

FIG. 1 illustrates a computer compilation system 100 in which one or more source code modules 102a-c are each translated by a compiler 104 into a respective object file 112a-c. Compiler 104 includes two components, a front end 106 and a back end 108. Generally, a front end 106 performs various analyses on a textual representation of a source code module, such as lexical analysis, syntactical analysis (also referred to as parsing), and semantic analysis. Front end 106 may produce an intermediate language representation 110a-c corresponding to each source code module 102a-c. Back end 108 may receive each intermediate language representation 110a-c and generate a corresponding binary representation. The binary representation may be referred to as an object code. As illustrated in FIG. 1, back end 108 produces object files 112a-c corresponding to respective intermediate language representations 110a-c. Typically, the front end and back end compilation of each source code module is performed independently of other source code modules, and each may be performed in a separate thread of execution or a separate process.

As further illustrated in FIG. 1, a linker 114 may combine object code from multiple modules. This may include a variety of operations, such as resolving references to symbols or relocating code. Linker 114 may produce an application executable 116.

FIG. 2 illustrates another compilation system 200, in which at least a portion of the code generation tasks have been shifted to the linker. In compilation system 200, compiler 204 includes a front end 206 that processes source code modules 202a-c and produces respective intermediate language (IL) representations 210a-c. Linker/code generator 214 performs linking and code generation operations, combining IL representations 210a-c and generating code, to produce an application executable 216.

Linker/code generator 214 performs link time code generation (LTCG). Link time code generation enables a variety of code optimizations to be performed, including optimizations that take advantage of knowledge of different functions, which may be in different modules. This is sometimes referred to as inter-procedural optimization. For example, a code generator may insert code to save certain registers prior to each function call and restore the registers upon returning from the function call. If a link time code generator can determine that a particular function does not change a specific register, it may avoid generating the register save and restore instructions around each invocation of that function, even if invoked from a different module. Another example of an optimization is to insert the code of a very short function inline where invoked, rather than insert instructions to call the function. By having knowledge of a first function when referenced by a second function, a code generator that operates during link time may perform inter-procedural optimizations such as these.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to compile a computer program using multiple threads. This may include using multiple threads to generate code for a plurality of source functions, where at least some of the threads execute concurrently, so that code is generated concurrently for some of the source functions. Code generation may perform various types of optimization, and may include optimizing the code based on knowledge of other functions, or inter-procedural code optimization.

A system may include a dependency analyzer component that analyzes dependencies among the functions. In one implementation, this may include creating a directed acyclic graph (DAG) based on references of the functions. This may include creating a directed graph, with nodes representing functions and edges representing dependencies, and breaking one or more dependencies in order to create a DAG. The system may include a code generator, which can be instantiated to create two or more code generator instances, in which each code generator instance executes in a respective thread and generates code for a respective function.

The system may include a scheduler component that schedules each code generator instance based on the DAG, so that at least two of the code generator instances may execute concurrently. The system may include an assembler component that aggregates the generated code of each function based on one or more sort keys, to create an aggregation of generated code in an ordering that is deterministically based on the source functions.

One aspect of the system is to deterministically create a binary file, such as an application executable, based on the input source files, such that compiling and generating code multiple times results in an identical output binary file each time, provided that the input source files and compiler specifications remain unchanged. The output is deterministic regardless of differences in a sequence of operations that may occur due to multi-threading and varying configurations. Individual object files may be deterministically produced as an intermediate step in creating an application executable.

In one aspect of the system, a code generator instance may perform one or more optimizations of code for a function based on information obtained from compiling another function. In one aspect of the system, information obtained from compiling a function may be selectively used to optimize code in another function, based on whether a broken dependency corresponding to either function exists, or more specifically, whether a dependency, which may be direct or indirect, of the other function on the function exists.

A system may employ mechanisms described herein to create an application executable that is deterministically based on the computer program, though the sequences of multi-threaded code generation may vary.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 shows one embodiment of a compilation system in which mechanisms of the present invention may be employed;

FIG. 2 shows one embodiment of another compilation system in which mechanisms of the present invention may be employed;

FIG. 3 is a block diagram generally showing components of a compilation system, in accordance with an embodiment of the present invention;

FIG. 4 is a diagram generally showing a graph that may be created and employed by a compilation system, in accordance with an embodiment of the present invention;

FIG. 5 is a table of functions and respective reference counts that illustrates methods of a compilation system, in accordance with an embodiment of the present invention;

FIGS. 6A-B are diagrams generally showing graphs that may be created and employed by a compilation system, in accordance with an embodiment of the present invention;

FIG. 7 is a table of functions and respective reference counts that illustrates methods of a compilation system, in accordance with an embodiment of the present invention;

FIG. 8 is a logical flow diagram generally showing a process of compiling a program, in accordance with an embodiment of the present invention; and

FIG. 9 is a logical flow diagram generally showing, in further detail, aspect of the process of FIG. 8, in accordance with an embodiment of the present invention.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. Similarly, the phrase “in one implementation” as used herein does not necessarily refer to the same implementation, though it may.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The components may execute from various computer readable media having various data structures thereon. The components may communicate via local or remote processes such as in accordance with a signal having one or more data packets (e.g. data from one component interacting with another component in a local system, distributed system, or across a network such as the Internet with other systems via the signal). Computer components may be stored, for example, on computer readable media including, but not limited to, an application specific integrated circuit (ASIC), compact disk (CD), digital versatile disk (DVD), read only memory (ROM), floppy disk, hard disk, electrically erasable programmable read only memory (EEPROM), flash memory, or a memory stick in accordance with embodiments of the present invention.

As used herein, the term “thread” refers to a thread of execution. A thread may be a software thread or a hardware thread. In a hardware multi-threaded processor, two or more threads may concurrently exist on the processor. Some processors provide multiple sets of registers or other components, so that multiple hardware threads may each have their own set of registers. A hardware multi-threaded processor may have a number of software threads that is greater than the number of hardware threads it supports. An operating system may manage the software threads, providing each a turn at executing as a hardware thread.

As used herein, a multi-threaded system is a system that supports multiple threads, which may be software or hardware threads. A multi-threaded system may or may not have hardware support for multi-threading.

As used herein, the term “function” refers to a portion of code within a larger program that performs a specific task, and can execute relatively independent of other portions of the program. A function may, but does not necessarily, return a value. In various computer languages, different terms may be used, such as subroutine, method, procedure, or subprogram. As used herein, the term “function” may include all of these.

An application executable is a data object that includes program instructions, typically in a binary formatted file. Generally, the program instructions are a machine code and correspond to processor instructions, though the program instructions may be in another format that is emulated by a processing system. An application executable may include various types of data related to program instructions, such as symbols, debugging information, exception information, strings, resources or the like. A compilation system may produce a single executable file, or it may produce a primary executable file, one or more library files, or associated resource files. As used herein, the term application executable may include one or more executable files, associated files, or a combination thereof. An application executable may also be one or more memory blocks, objects in a database, or other forms of data.

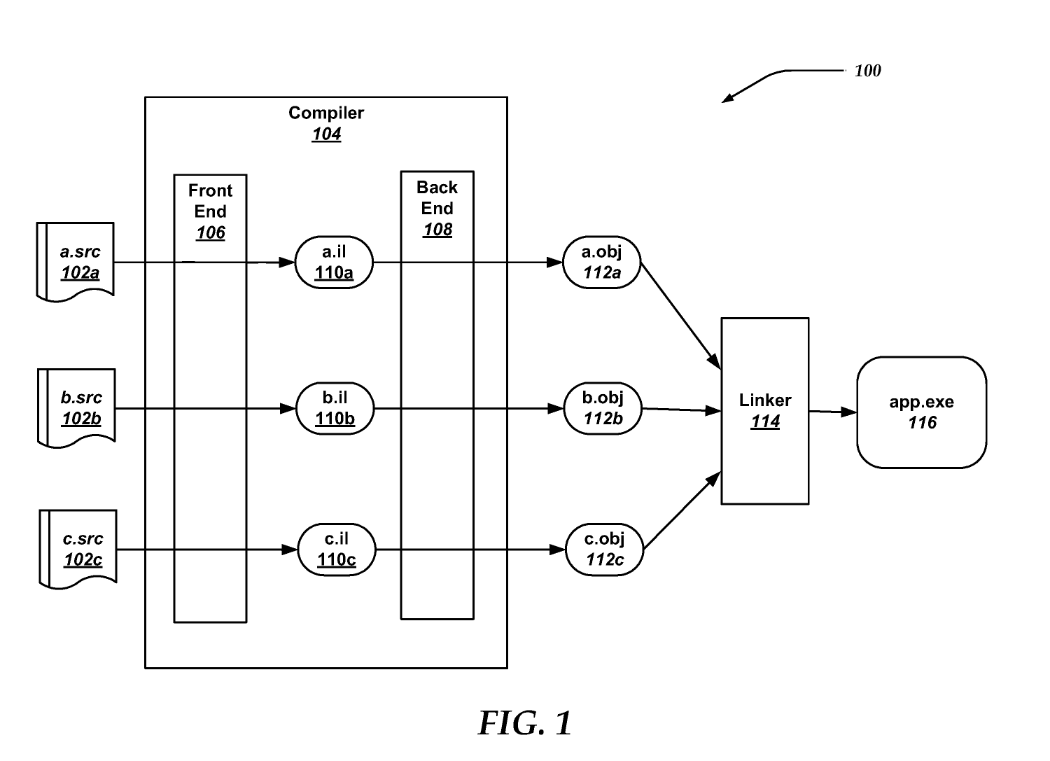

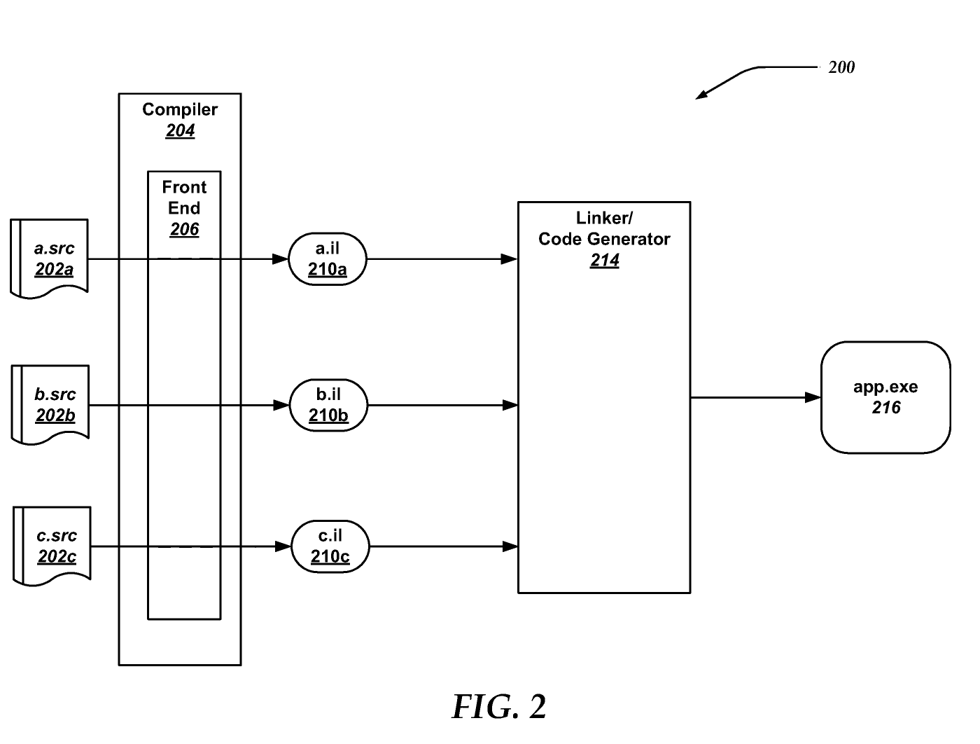

In a compilation system, such as compilation systems 100 and 200 of FIGS. 1 and 2, respectively, it is generally desirable to have a deterministic output. That is, for a given set of source files, each time the source files are compiled to produce an application executable, the application executable is identical, or very nearly identical, to the application executable produced each other time, provided that the source files and compiler specifications are not changed. Even if the compilation system configuration is altered, such as by using a different computing device, altering the hardware or software configuration, or activating other software processes, the application executable is identical. This is desirable because it provides a consistent situation for testing and debugging the target program. A programmer may, for example, compile, run, and debug a program on different systems, and, by employing mechanisms described herein, is able to depend on the constancy of the application executable. This feature is referred to as deterministic output. It may be said that an output is deterministically based on an input, if a process of creating the output from the input results in identical, or nearly identical, output, regardless of differences that may occur during processing for each iteration, except for system failures. More specifically, in a compilation system, output object or binary files are deterministically based on an input source files if corresponding output files are identical, or nearly identical each time the input source files are processed, regardless of system configuration differences across the different processings.

In some implementations, it may be acceptable to have a deterministic output that is not exactly identical each time, but is nearly identical. Differences may be within a tolerance acceptable by a user, or may even be due to a desirable feature, such as inclusion of a timestamp. Such differences are contemplated and are within the scope of the invention as described and claimed. Thus, the term “deterministic output” allows for such minor variations in the application executable.

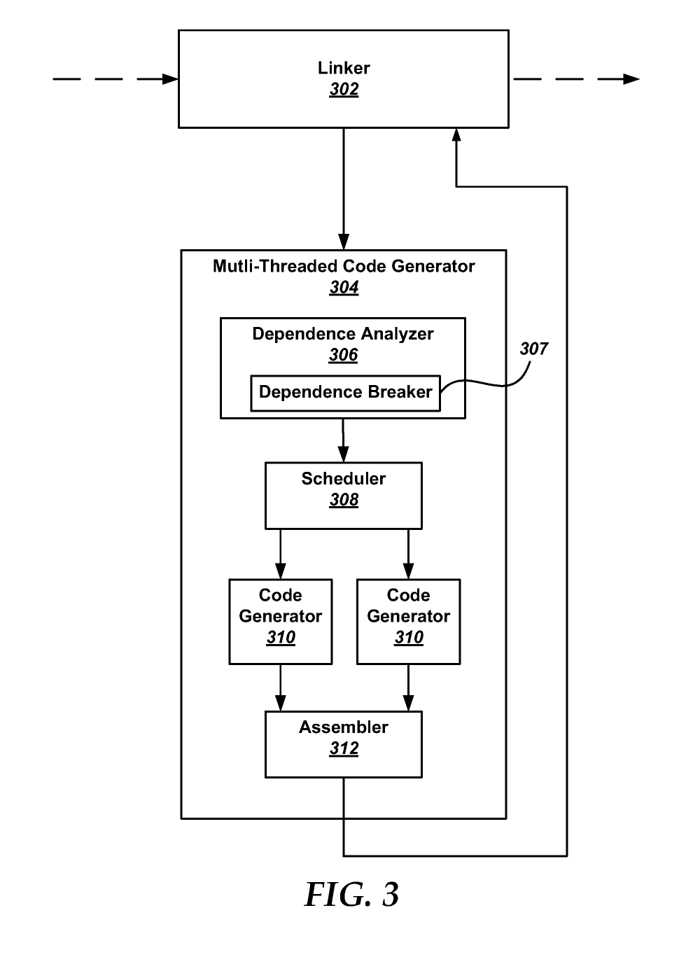

FIG. 3 is a block diagram of a multi-threaded compilation system 300. In one implementation, multi-threaded compilation system 300 may be used as a part of, or in conjunction with, compilation system 200 of FIG. 2. For example, multi-threaded compilation system 300 may be employed as linker/code-generator 214 of FIG. 2. In one implementation, multi-threaded compilation system 300 may be used as part of, or in conjunction with, compilation system 100 of FIG. 1. For example, components of multi-threaded compilation system 300 may be employed as back end 108 of FIG. 1. In much of the discussion herein, the configuration of compilation system 200 is used to describe the mechanisms of multi-threaded compilation system 300; however the invention is not so limited.

Multi-threaded compilation system 300 is only one example of a suitable system and is not intended to suggest any limitation as to the scope of use or functionality of the present invention. Thus, a variety of system configurations may be employed without departing from the scope or spirit of the present invention.

As illustrated, multi-threaded compilation system 300 includes linker 302. Linker 302 may perform many of the operations of a conventional linker. Linker 302 may also, upon receiving input objects, determine whether the objects include object code or intermediate language representations and, if the objects include IL representations, send them to the multi-threaded code generator 304 for further processing.

Multi-threaded code generator 304 may receive IL representations corresponding to various functions, and process them. Following is a brief introduction to each component. A more detailed discussion of the mechanisms employed is provided below. As illustrated, multi-threaded code generator 304 includes dependence analyzer 306. Briefly, dependence analyzer 306 analyzes dependencies among the program functions it receives. In one implementation, it may generate a directed graph of dependencies among the program functions, and may further process the directed graph to produce a directed acyclic graph (DAG). In one implementation, dependence analyzer 306 includes a dependence breaker component 307 that performs actions related to converting a directed graph to a DAG. Operations of dependence analyzer 306 are described in further detail herein.

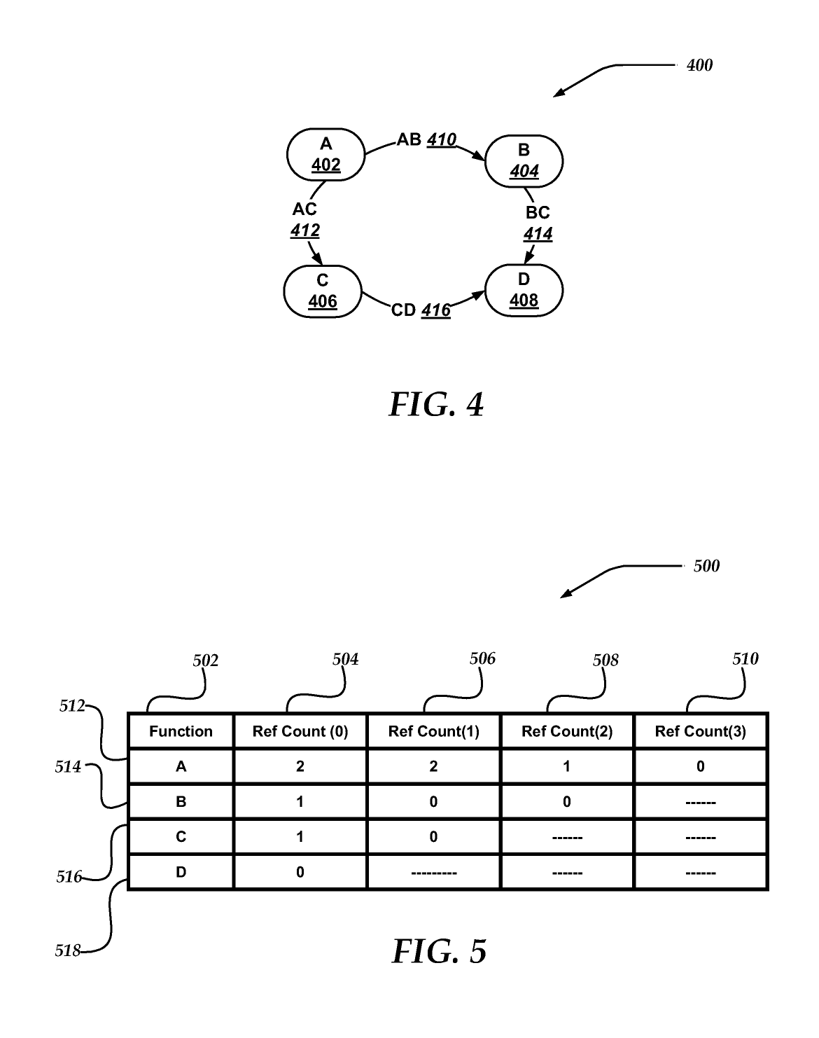

Multi-threaded code generator 304 may further include scheduler 308 and one or more instances of a code generator, each instance referred to herein as code generator instance 310. Briefly, scheduler 308 may schedule each function to be processed by code generator instance 310. It may, for example, insert each function in a queue when the function is ready to be processed. Functions may be removed from the queue and processed by code generator instance 310, thereby enforcing an ordering of processing and limiting concurrent processing to those functions that have been inserted into the queue. Scheduler 308 may determine an ordering to schedule functions based on the analysis produced by dependence analyzer 306. For example, in one implementation, dependence analyzer 306 may generate a hierarchical structure such as a DAG, and scheduler 308 may employ a bottom-up scheduling, such that leaves of the directed graph may be processed prior to nodes at a higher level. Further at any state of the graph, two or more leaves of the DAG may be processed concurrently. Leaves of the DAG may be conceptually removed from the DAG as they are processed by the code generator instance 310, so that each iteration of code generation processes a leaf of the DAG that remains. This process is illustrated and discussed in more detail in FIGS. 4-7 and elsewhere herein.

Though not illustrated, in one embodiment, scheduler 308 may employ a top-down scheduling, such that roots of the directed graph may be processed prior to nodes at a lower level. Inter-procedural optimizations may include optimizations that use information on calling functions to optimize code of a called function. For example, a called function might be optimized if it is known that all of its caller functions pass a specific constant as an argument, or pass constants within a known range of values. Similarly, other optimizations may be available if characteristics of calling functions are known.

Code generator instance 310 may process each function it receives, generating “contributions.” Contributions may include object code, symbol tables, debugging data, exception information, fix up data, unwind information, or the like. Briefly, fix up data refers to data, such as a symbol, that needs to be resolved by the linker. Unwind information is used by a runtime library to perform actions, such as unwinding the runtime stack when there is an exception. The contributions are generally data that may be included in a final executable binary or associated data object, or are used at a subsequent processing stage, such as by the linker. Multiple code generator instances 310 may each operate in a respective thread, so that in various configurations there may be one or more code generating threads of operation. The number of threads may vary according to the hardware or software configuration, available resources, other processes active on the computing system, or various other factors. Thus, for example, at various times there may be one, two, or more code generators active.

The threads of code generator instance 310 may be software threads or hardware threads. Each thread may execute in a single-threaded or multi-threaded processor. Code generator instance 310, as well as other components of multi-threaded compilation system 300, may execute on a single-threaded or multi-threaded processor architecture. Different code generator instances 310 may execute on respective threads in the same core, different cores within the same processor, or different cores on different processors.

In some implementations, processing a function by code generator instance 310 may be performed by creating a thread to perform code generation tasks corresponding to the particular function. The thread may be terminated upon completion. In some instances, a thread may be reused. That is, a code generator instance 310 may process a function within a thread and, upon completion of actions corresponding to the function, receive a new function for processing (or wait for a new function if one is not ready to be processed or if the system configuration requires the thread to wait). Mechanisms described herein may be used with these or other variations, or combinations thereof.

A code generator component implemented in a thread is referred to as an “instance” of the code generator. As discussed herein, two or more instances of the code generator may, within the restrictions described, perform actions concurrently. Multiple active threads may perform actions concurrently, whether they are software threads or hardware threads, or whether they are on the same or different processing units. As used herein, the term concurrent refers to actions that may include partial concurrency, interleaved processing such as by time-slicing, or processes whereby one thread may actually be in a wait state while another thread is performing instructions. Thus the term concurrent includes variations of concurrency as is generally understood with respect to software and hardware threads.

In a compilation system in which portions of the compilation may be performed by concurrent threads, issues relating to producing deterministic output may arise. For example, when generating or optimizing code for a first function that calls a second function, various optimizations may be performed if the system has information relating to the second function, such as which registers the second function uses, the length of the second function, whether the second function modifies a global variable, or the like. If a multi-threaded system may process either the first function or the second function before the other, the resultant output, and specifically the application executable, may differ, and is therefore not deterministic. As discussed herein, mechanisms of the invention operate to perform multi-threaded compilation and optimization, while producing deterministic output.

One such mechanism is the queue discussed above. The scheduler 308 may include logic that determines, based on the analysis performed by the dependence analyzer 306, which functions may be safely placed in the queue at any particular time, such that the functions may be processed concurrently, while facilitating a deterministic output. The scheduler 308 further determines an ordering of functions to process, based on the analysis of the dependence analyzer 306.

In the embodiment illustrated by FIG. 3, multi-threaded code generator 304 further includes an assembler 312. Assembler 312 may receive the contributions corresponding to each function, and assemble them in a deterministic order. As discussed herein, a deterministic order is employed so that for a set of functions, the output produced by assembler 312 will be the same each time the mechanisms described herein are employed, provided the set of functions remains unchanged. In one implementation, assembler 312 may assemble the contributions in a first order, and then sort them based on one or more keys to produce a deterministic result. In one implementation, assembler 312 may assemble the contributions in a manner so that the result is in a deterministic order, based on one or more keys. Insertion sort is one such technique that may be employed. Regardless of the implementation, it may be said that the assembler assembles and sorts contributions, though the sorting logic may be integrated into the assembling process. It is to be noted that the term “assembler” is sometimes used in the art to indicate a component that translates assembly code; this is not the meaning as used herein.

In one implementation, assembler 312 may produce one or more object files or data objects corresponding to each input source module. The output of assembler 312 may be passed back to linker 302 to perform linking operations, such as resolving memory or symbol references, relocating code, or other actions. In one implementation, linker 302 may output a binary file, such as an application executable.

The components of multi-threaded compilation system 300 are presented to show functional or logical aspects of a multi-threaded compilation system. However, these logical components may be implemented in a variety of ways. They may be implemented as separate software components or hardware and software combinations, integrated into a single component, or physically divided in a number of ways. Reference to each component herein refers to a logical component and includes the various configurations that may be used to implement the functionality discussed. They may be implemented on a single computing device or distributed among multiple computing devices in a variety of configurations.

In brief, one embodiment of a computing device that may be employed includes one or more central processing units, a video display adapter, and a mass memory, all in communication with each other via a bus. Each processor may employ a chip multi-processing architecture (CMP), a symmetric multi-threading (SMT) architecture, or a chip multi-threading (CMT) architecture. Briefly, CMP refers to a processor architecture in which there are multiple processor cores per processor chip. SMT refers to a processor architecture in which a processor core has multiple hardware threads of execution. CMT refers to a processor architecture having multiple processor cores per processor chip and multiple hardware threads of execution per core.

The mass memory may include a random access memory (RAM), a read only memory (ROM), one or more permanent mass storage devices, removable media, or a combination thereof. Mass storage devices may include a hard disk drive, optical drive, flash memory, or a floppy disk drive. The mass memory may include a general-purpose operating system, application programs, security programs, communication programs, or other computer programs.

In accordance with one aspect of the mechanisms described herein, dependence analyzer may analyze the functions that it receives as input to determine relationships among functions based on dependencies between them. In various implementations, the results of the analysis may be represented in a variety of ways. One such representation is a directed graph, which represents dependency relationships between pairs of functions. A directed graph may itself be represented in numerous ways. These include, but are not limited to, a set of binary relations, an adjacency matrix, a linked list, or a text string. As used herein, the term directed graph refers to a logical representation that indicates directed relationships between pairs of functions. It is not limited to a particular representation, unless stated otherwise. FIG. 4 is a diagram generally showing a directed graph 400 that may be generated by a compilation system, such as multi-threaded compilation system 300, based on a specific set of input functions, in one embodiment. Directed graph 400 may be generated by dependence analyzer 306 of FIG. 3, based on the intermediate language representations of the functions represented therein. Each of the nodes in the directed graph 400 represents a corresponding function that is input to the compilation system, and is referred to in this discussion by its function name. Thus, directed graph 400 includes function A 402, function B 404, function C 406, and function D 408. Each of functions A-D 402-408 may reside in a different input source module or may be combined in a variety of ways in one or more input source modules. Each of the directed edges, or arrows, represents a dependency of one function on another, and is labeled by the names of the two functions of the dependency relationship, with the dependent function named first. Thus, dependency AB 410 represents a dependency of function A on function B; dependency AC 412 represents a dependency of function A on function C; function BC 414 represents a dependency of function B on function C; and dependency CD 416 represents a dependency of function C on function D.

As used herein, the term dependency refers to a reference to the dependee function by the dependent function, such that the reference may indicate information relating to the dependee function that may be useful for the optimization of the dependent function. The reference may be the result of an invocation of the dependee function, a use of a variable, data object, or other element defined by the dependee function, or the like.

Directed graph 400 does not contain any directed cycles, and is therefore a directed acyclic graph (DAG). As discussed for a directed graph, a DAG may be represented in a variety of ways, and reference to a DAG is not limited to any particular representation unless stated otherwise herein. Function D is a leaf node of the DAG, in that it does not have any dependencies on other nodes of the DAG. Function A is a root node of the DAG, in that it is not a dependee of any other function. A DAG may have one or more leaf nodes and one or more root nodes.

Generally, employing concurrency of code generation, by using multiple instances of a code generator, each in a different thread, may improve performance of the compilation process. However, mechanisms described herein may place restrictions on concurrency, and enforce an ordering, in order to facilitate optimization and generate a deterministic result.

Reference to FIG. 4 illustrates this concept. Based on the directed graph 400, a multi-threaded code generator may generate code for function D 408. Once processing of function D 408 is completed, code may be generated for each of functions B 404 and C 406. Neither of these functions references the other, and code may be concurrently generated for both functions. After processing of both function B 404 and C 406 is completed, code may be generated for function A 402. Thus, there are three phases of code generation for functions A-D, and during the second phase, multi-threading may be used to generate code for functions B and C. Note that in some configurations, only a single thread may be available, and either function B or function C may be processed first, but in either case, as with a configuration allowing two threads, the resultant output is deterministic.

Assembler 312 (FIG. 3) may receive the contributions corresponding to each function A-D, and assemble them to produce an object file corresponding to each input source module. As discussed herein, the contributions may be sorted based on one or more keys, so that the resultant output is deterministic, regardless of the possible variability of completion for each of the functions. In one embodiment, one or more keys are used so that at least the program instructions correspond to the original input source files. However, other keys may also be used.

FIG. 5 is a table 500 that illustrates reference counts corresponding to each of the functions A-D 402-408 of FIG. 4. Rows 512-518 correspond to functions A-D 402-408, respectively. Column 502 includes the name of each function A-D. Table 500 includes multiple columns 504-510 representing reference counts at four different times during the code generation of functions A-D. It may correspond to a logical table having a single reference count column employed by scheduler 308 of FIG. 3. A reference count of a function refers to an unsatisfied dependency by the corresponding function. Note that an unsatisfied dependency refers to a dependent-dependee relationship, and not to the number of references between a dependent and dependee function.

Column 504 indicates the reference count of each function at a time (0), which is prior to beginning code generation for any of the functions. As can be seen by directed graph 400, and the discussion above, function A 402 has two references, functions B 404 and C 406 have one reference, and function D 408 has zero references. A function having zero references may be ready to be processed by code generator instance 310. In one implementation, this may be performed by inserting function D onto the code generation queue. A code generator instance 310 may retrieve function D from the queue and process it, producing its contributions, including program instructions. In one implementation, a scheduling process may create a new thread, or reuse an existing thread, and pass to the thread a function that is ready to be processed. In one implementation, a code generation thread may retrieve a function that is ready to be processed, process it, and then retrieve another function, blocking when there is not a function that is ready to be processed.

When code generation for function D 408 is completed, the reference count for each function that references function D may be decremented, indicating that the dependency has been satisfied. A dependency is considered satisfied when the dependee function has been processed by the code generator. Prior to that, the dependency is considered unsatisfied. Column 506 indicates the updated reference counts, at time (1), after code generation for function D 408 is completed. As illustrated, reference counts corresponding to functions B and C have been decremented to zero. Note that row 518 representing function D may be logically flagged or removed from the table. In some implementations, function D may be flagged or removed when it is retrieved from the queue. Functions B and C may now be logically considered to be leaf nodes of the remaining DAG.

Functions B 404 and C 406 may now be processed. Each function may be processed by a corresponding code generator instance 310, executing concurrently in a corresponding thread. For illustrative purposes, column 508 illustrates a possible state if processing of function C completes first, at time (2). The reference count of function A 402 is decremented to one, and function C is flagged or removed. Since function A still has a non-zero reference count, its processing is not yet started.

Column 510 illustrates a state after processing of function B 404 completes, at time (3). The reference count for function A is decremented to zero, and function B is flagged or removed. Function A may now be placed on the queue and retrieved by a code generator instance. Upon completion of code generation for function A, there are no other functions to process, and the resulting contributions for each function are assembled and sorted by the assembler 312, as discussed herein.

It is to be noted that starting or completion of code generation for each function is described for illustrative purposes. In some implementations, a thread may begin processing of a function to perform initialization or code generation until a point where a code optimization decision relating to an unprocessed dependee function is to be made, and then block. For purposes of this discussion, this is considered as not yet started. Similarly, at a point of code generation when all information that may be used by a dependent function has been generated, the code generator instance may perform additional processing, though for purposes of this discussion, this may be considered as completed.

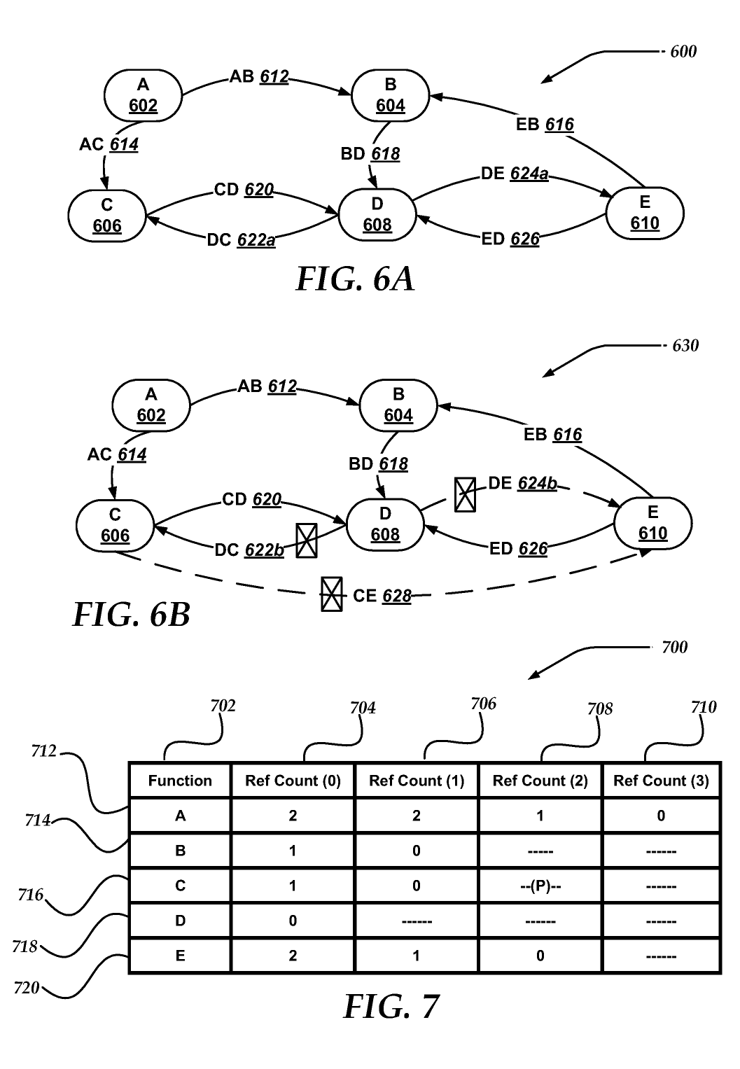

FIG. 6A is a diagram generally showing another directed graph 600 that may be generated by a compilation system, as described for FIG. 4, but based on a different set of input functions. Directed graph 600 may be generated by dependence analyzer 306 of FIG. 3. The directed graph 600 includes function A 602, function B 604, function C 606, function D 608, and function E 610. Dependency AB 612 represents a dependency of function A on function B; dependency AC 614 represents a dependency of function A on function C; dependency EB 616 represents a dependency of function E on function B; dependency BD 618 represents a dependency of function B on function D; dependency CD 620 represents a dependency of function C on function D; dependency DC 622a represents a dependency of function D on function C; dependency DE 624a represents a dependency of function D on function E; and dependency ED 626 represents a dependency of function E on function D. Thus, each dependency is named by joining the name of the dependent function followed by the name of the dependee function, where the terms dependent and dependee are with respect to a specific dependency.

Directed graph 600 contains three cycles. Dependencies CD 620 and DC 622a form a cycle between functions C and D. Dependencies DE 624a and ED 626 form a cycle between functions D and E. Also, dependencies BD 618, DE 624a, and EB 616 form a cycle between functions B, D, and E. One aspect of the mechanisms described herein is to convert a directed graph into a directed acyclic graph (DAG) by breaking one or more dependencies. This may be performed in a deterministic way, so that the process of converting a directed graph with cycles to a DAG is deterministic. It should be noted that forming a DAG is considered deterministic when logic causes the results of multiple conversions of an equivalent input graph to form equivalent DAGs. Two DAGs are considered equivalent when they are topologically equivalent. That is, the ordering of nodes on two equivalent DAGs may differ, if the difference does not affect the topology. For example, a DAG is considered equivalent to its own mirror image. Two or more equivalent DAGS have the same dependency relationships.

FIG. 6B illustrates a DAG 630 that results from processing the directed graph 600, by breaking two dependencies. Like numbered components of FIG. 6B represent like numbered components of FIG. 6A. In FIG. 6B, however, dependency DC 622a of FIG. 6A has been “broken.” The broken dependency DC 622b is indicated by a dashed arrow with a superimposed “X”. Similarly, dependency DE 624a of FIG. 6A has been broken, and is indicated by broken dependency DE 624b in FIG. 6b. The remaining dependencies form a directed graph without cycles, so the graph is therefore a DAG. Function A 602 is a root node of DAG 630, and function D 608 is a leaf node. Function E 610 is also a root node of DAG 630, since it is not a dependee of any other function. Actions of breaking dependencies and converting a directed graph to a DAG may be performed by dependence breaker 307 of FIG. 3.

FIG. 7 is a table 700 that illustrates reference counts corresponding to each of the functions A-E 602-610 of FIG. 6B during an example compilation of the illustrated functions. As discussed herein, due to the indeterminate nature of multi-threaded operation, the sequence of code generation may vary between different performances of the multi-threaded compilation process, and table 700 merely illustrates one example that may occur. Rows 712-720 correspond to functions A-E 602-610, respectively. Column 702 includes the name of each function A-E. Columns 704-710 represent reference counts at four different times during code generation of functions A-E.

The representation of table 700 to illustrate scheduling of code generation is similar to that described for FIG. 5. Column 704 indicates the reference count of each function at time (0). Function D, having a zero reference count, may be processed first by code generator instance 310. The reference counts for functions B, C, and E may then be decremented once due to their respective dependencies on function D; the reference count for function A remains unchanged. In one implementation, the reference counts for functions B, C, and E are decremented after processing of function D is completed. Column 706 indicates the reference count of each function at time (1), after function D has been processed.

Functions B and C may now be processed concurrently, each in a respective code generator instance 310, executing in a respective thread. Note that, due to the variance in multi-threaded sequences, and also allowing that a particular system configuration may cause a single thread to be used to run two code generator instances 310 sequentially, code generation for functions B and C may be completed approximately together, or either one may occur prior to the other. In some configurations, processing one of these functions may complete before the other even begins. Three possible sequences for the completion of code generation of each function in DAG 630 are DBCEA, DBECA, and DCBEA, further illustrating the variation in the processing by a multi-threaded compilation system. Note that although function E is a root node of DAG 630, it is not necessarily processed prior to all non-root nodes.

Table 700 illustrates, in column 708, a situation in which code has been generated for function B. The string “—(P)—” indicates that function C has at least been added to the queue for processing, but has not completed processing. Function C may have been partially concurrent to function B, or completely sequential. Code generation may, at this point, proceed for functions C and E, each in a code generator instance 310, each in a respective thread. Alternatively, functions C and E may be processed sequentially. In one configuration, function E may complete processing prior to function C's completion, or even prior to the beginning of processing for function C. Column 710 illustrates a state in which code generation has been completed for functions C and E, and code generation for function A is ready to begin.

Upon completion of code generation for function A, there are no other functions to process, and the resulting contributions for each function are assembled and sorted by the assembler 312, as discussed herein.

FIGS. 6A-B and 7 illustrate an aspect of the mechanisms of multi-threaded code generation relating to broken dependencies. One embodiment of a multi-threaded code generation system keeps track of broken dependencies in order to avoid using information that may be obtained if a broken dependee function is processed prior to a corresponding broken dependent function having a broken dependency. Note that the terms “broken dependee” and “broken dependent” refer to a dependency relationship that is broken. In the configuration of FIGS. 6A-B and table 7, functions C 606 and E 610 are broken dependee functions relative to broken dependent function D 608 and broken dependencies DC 622b and DE 624b, respectively. Therefore, code generation for function D does not use information obtained from processing of functions C and E. Though function D is processed prior to functions C and E (because of dependencies CD 620 and ED 626), the combination of dependencies CD 620 and broken dependency DE 624b forms a broken dependency between function C and function E, illustrated as dependency CE 628. If, for example, function C is optimized by inserting code from function D inline in function C, function C inherits the dependencies of function D, including the broken dependencies. Hence, dependency CE 628 is an inherited broken dependency.

In the example of DAG 630 discussed above, functions C and E may be processed concurrently. Moreover, either one of functions C or E may be processed prior to the other, or varying amounts of concurrency may occur. Thus, code generation for function C behaves as if function E has not yet been processed. Information obtained while processing function E is not used during code generation of function C. This enables the code generated for function C to be deterministic, such that it may be identical regardless of the sequence during a particular code generation. It may be said that a broken dependee function is hidden from a corresponding broken dependent function. (e.g. Function E is hidden from function C.) It is to be noted that if program code is modified in any of the functions A-E, and a recompilation is performed, a different DAG may result, such that the subsequently generated code is not necessarily equivalent to code generated prior to the modification.

In one embodiment, a user may specify that one or more functions, or all functions, are to be processed without inter-procedural optimization. In this embodiment, all dependencies in which the indicated functions are dependent functions may be broken, so that all such functions may be leaves of DAG, and may be ready for code generation without waiting for other functions to be processed. In a configuration in which a specification that all functions are to be processed in such a manner, in one implementation all dependencies may be broken, allowing concurrent processing of any functions. In one implementation in which all functions are specified to be processed without inter-procedural optimization, the actions of analyzing dependencies may be skipped, such that all functions may be initially placed on a processing queue.

FIG. 8 is a flow diagram illustrating a process 800 of compiling a program, in accordance with an embodiment of the present invention. Process 800 may employ multi-threading system 300 of FIG. 3, or a portion thereof. It may be employed by the linker/code generator 214 of FIG. 2. It may also be employed by the back end 108 of FIG. 1. It may employ any of the system variations discussed herein, or it may be performed with other systems.

As illustrated in FIG. 8, process 800 may begin, after a start block, at block 802, where each function in a set of source functions is partially compiled. The functions may be compiled into respective intermediate forms, referred to herein as intermediate language (IL) objects. Each IL object may be stored in an associated file or in another data configuration. In some configurations, the set of input source functions may be an improper subset of the source functions that make up the program. The remaining programs, for example, may be compiled using different mechanisms. In one configuration, the remaining functions may have been previously processed using the mechanisms described herein, separately from the functions currently being processed. Thus, reference to functions of a program does not necessarily mean all functions of the program, unless stated otherwise.

Processing may flow to block 803, where an analysis of function dependencies is performed, for the set of source functions. A dependency on a dependee function X may represent a call to function X, a reference to a variable or data object defined by function X, or another reference such that information relating to function X may be used to optimize the dependent function.

In one implementation, analysis of function dependencies may include generation of a directed acyclic graph (DAG). FIG. 8 illustrates one such implementation, in which blocks 804 and 806 are included in the actions of block 803, though the mechanisms described herein may employ other implementations. As illustrated, in block 804, a directed graph of function dependencies is generated for the set of source functions.

Processing may flow to block 806, where the directed graph is converted to a directed acyclic graph (DAG). This may include actions of breaking one or more dependencies from the directed graph in order to remove cycles. If the directed graph generated at block 804 is already a DAG, the actions of block 806 may be skipped. The DAG may include nodes that represent functions and arrows that represent dependencies, as described herein.

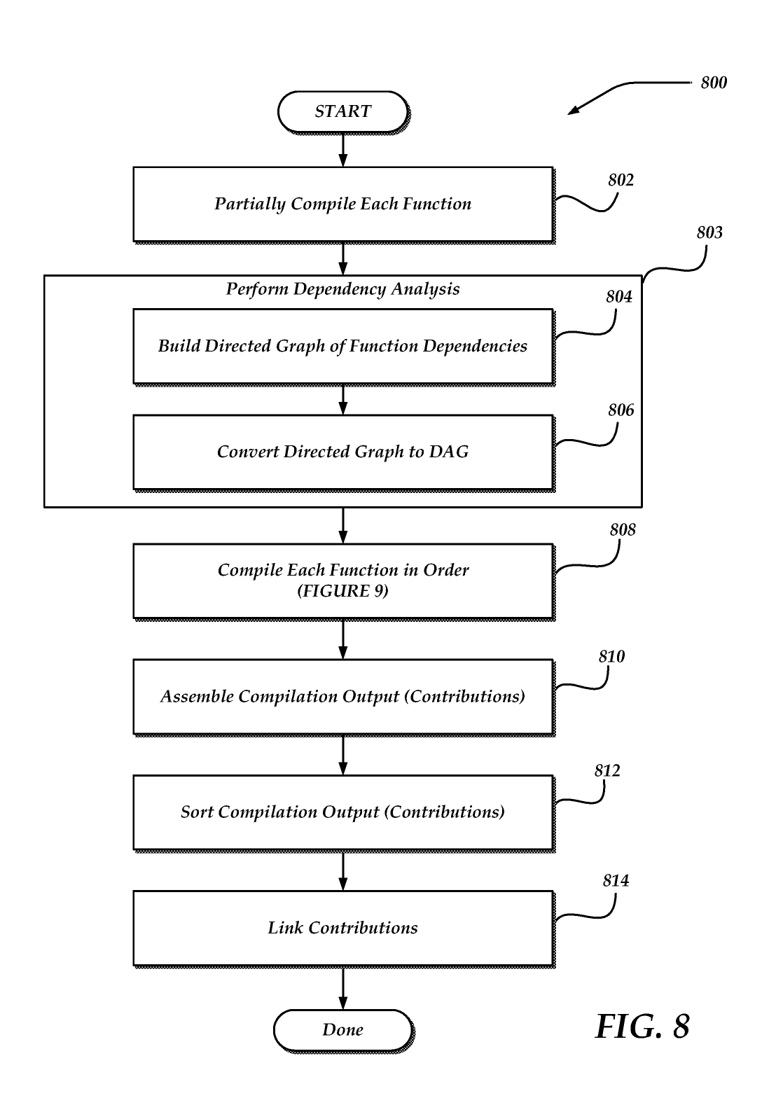

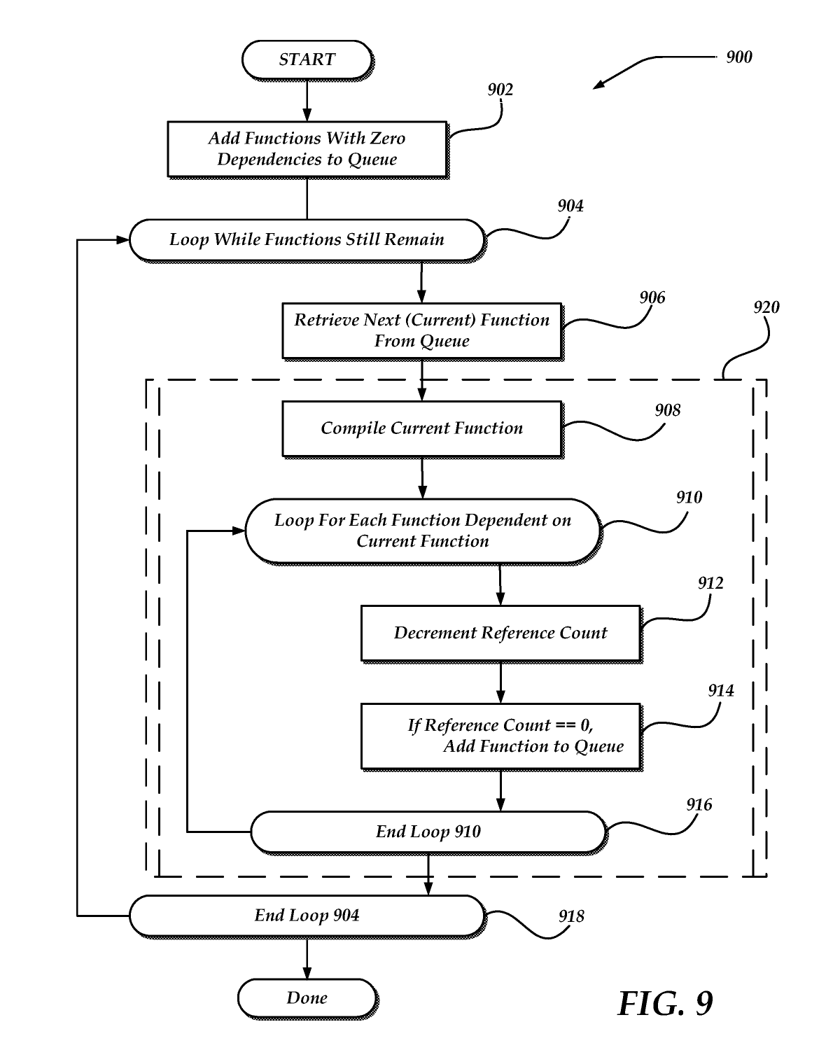

Processing may flow to block 808, where each of the functions represented in the DAG is further compiled. The actions of block 808 are illustrated in more detail in FIG. 9. Briefly, these actions include determining a scheduling of each function to enable concurrent, multi-threaded compilation of some functions, enforcing some sequencing of function compilation, and generating a deterministic output of contributions corresponding to each function. The actions of block 808 may include generating code for each function and performing one or more optimizations of program instructions for some functions based on information related to the compilation of other functions.

Processing may flow to block 810, where the compilation output, referred to as contributions, for the functions represented in the DAG are combined and assembled. In one implementation this may result in a single intermediate file or data object, though other implementations may generate multiple files or data objects. In one implementation, one intermediate file is created for each input source file. Processing may flow to block 812, where the contributions corresponding to the functions are sorted based on one or more keys. In one implementation, a key may be selected to generate an ordering that at least approximately matches an ordering in the input source. As described herein, at least some of the actions of sorting may be combined with the actions of assembling, or they may be performed prior to assembling. FIG. 8 breaks the actions of assembling and sorting into two blocks for illustrative purposes.

Processing may flow to block 814, where the assembled contributions may be further processed by performing linking operations. Linking operations may include resolving memory or symbol references, relocating code, or other actions of conventional linkers. The result of block 814, and process 800, may be an application executable file or object that is deterministically produced based on the input source. If process 800 is performed multiple times on identical input sources, the application executable produced by each iteration will be identical, or at least equivalent and substantially identical, to each other application executable, regardless of differences due to concurrent compilation of some functions.

FIG. 9 is a flow diagram illustrating a process 900 of compiling the functions of a DAG, such as the DAG described in FIG. 8. Process 900 may be performed as at least a portion of process 800 of FIG. 8, such as within block 808 of FIG. 8. Process 900 may use a DAG as input data. Process 900 may employ multi-threading system 300 of FIG. 3, a portion thereof, or variations thereof.

As illustrated in FIG. 9, process 900 may begin, after a start block, at block 902, where functions having zero dependencies are added to a processing queue. The queue serves as a mechanism for enabling functions that are ready to be processed to be processed. Though a queue is discussed herein, in some implementations, other mechanisms may be employed, and some features of a queue are not needed. For example, a queue typically employs a first in first out mechanisms, though process 900 may implement a mechanism such that functions may be removed from the processing queue in an order different than the order they are placed on the queue. The ordering of removal may be arbitrary or it may be based on a characteristic of the functions, such as the number of functions that depend upon it, or any other characteristic.

By way of example, if the process 900 is performed on the functions of directed graph 400 (which is a DAG) of FIG. 4, function D 408 may be placed on the queue at block 902; if the process 900 is performed on the functions of DAG 630 of FIG. 6B, function D 608 may be placed on the queue at block 902.

Processing may flow to block 904, where a loop begins, referred to herein as loop 904. Loop 904 may iterate until all functions of the DAG have been processed, and therefore no more functions remain.

Processing within loop 904 may proceed to block 906, where the next function is retrieved from the processing queue. Within loop 904, this retrieved function is referred to as the “current” function. As discussed above, in various implementations, various mechanisms may be used to determine the next function to retrieve from the queue, when more than one function is on the queue.

Processing may flow to block 908, where the current function is compiled. Compiling the current function may include generating code, optimizing the code, producing symbol tables, debug information, exception information, or other information, referred to as contributions corresponding to the current function.

Processing may flow to block 910, where an inner loop begins, referred to herein as inner loop 910. Inner loop 910 may iterate for each function that is dependent on the current function, based on the DAG. Within inner loop 910, the dependent function that is being iterated on is referred to as the current dependent function.

Processing may flow to block 912, where the reference count for the current dependent function is decremented by one, indicating that one dependency has been removed. In one implementation, actions of accessing or decrementing the reference count may employ synchronization or locking operations to facilitate multiple threads accessing or modifying data such as the reference counts. Processing may flow to block 914, where a determination is made of whether the reference count for the current dependent function has been decremented to zero, indicating that it has no active dependencies. If this is true, the current dependent function is added to the processing queue, as discussed herein, such as with reference to block 902.

Processing may flow to block 916, which terminates inner loop 910. If there are additional functions that are dependent on the current function to iterate over, processing may flow back to the beginning of inner loop 910 to continue processing the next dependent function. If there are not additional functions to iterate over, the processing may exit inner loop 910 and flow to block 918.

FIG. 9 illustrates a thread 920, indicated by dashed lines. In one implementation, thread 920 includes blocks 908-916. For example, after performing the retrieval action of block 906, a thread 920 may be created or reused, such that the actions of blocks 908-916 are performed within the thread, and such that more than one such thread 920 may execute at least partially concurrently, each thread 920 performing actions on a respective current function. In some configurations, the use of concurrent operations as described herein may result in a reduction in time for performance of code generation processes. Mechanisms described herein may facilitate a performance improvement while maintaining a deterministic output.

In different implementations, the particular actions that are performed in thread 920 may vary to more or less than those illustrated in FIG. 9. For example, the action of block 906, retrieving the next function from the queue, may be performed within thread 920. In one implementation, some or all of the actions of inner loop 910 may be performed outside of thread 920. In one implementation, the compiling actions of block 908 may be divided such that some are performed within thread 920 and some are performed outside of thread 920. In one implementation, thread 920 may itself be subdivided into two or more threads, such that some of the actions of blocks 908-916 are divided among the two or more threads.

In the embodiment of process 900 as illustrated in FIG. 9, following inner loop 910, or following the creation or reuse of thread 920, processing may flow to block 918, which terminates loop 904. If there are additional functions that remain to be processed, processing may flow back to the beginning of loop 904 to continue processing the next function. If there are no additional functions to process, the processing may exit loop 904 and flow to a done block, where the process may return to a calling program or process, such as process 800. Though not explicitly illustrated in FIG. 9, process 900 may include, prior to performing the retrieving action of block 906, waiting for a function to be placed on the processing queue, for example, by the action of block 914, which may occur in a thread other than the main thread. In some configurations, in which the number of threads is limited, actions of starting a new thread 920 may include waiting for a thread to become available. Various other synchronization actions may also be performed to facilitate multi-threaded processing.

It will be understood that each block of the flowchart illustrations of FIGS. 8-9, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A system for compiling a computer program having a plurality of functions, comprising:
a) a dependency analyzer component configured to perform actions including analyzing dependencies among the plurality of functions;
b) a code generator component configured to enable at least two instances of the code generator, each code generator instance executing in a respective thread and performing actions including generating code corresponding to a corresponding function of the plurality of functions; and
c) a scheduler configured to perform actions including scheduling each code generator instance to enable the at least two code generator instances to execute at least partially concurrently, the scheduling based on the analysis of dependencies among the plurality of functions.

2. The system of claim 1, further comprising an assembler component configured to perform actions including aggregating the generated code corresponding to each function in an ordering to create a deterministic aggregation of generated code.

3. The system of claim 1, further comprising an assembler component configured to perform actions including aggregating the generated code corresponding to each function based on a sort key to create an aggregation of generated code that is deterministically based on the plurality of functions.

4. The system of claim 1, wherein the dependency analyzer component actions comprise actions including generating a directed graph and, if the directed graph is cyclic, converting the directed graph to a DAG.

5. The system of claim 1, wherein the scheduler enables code generation for a first function to be performed concurrently with code generation for a second function, and information obtained from compiling the second function is selectively used to perform at least one optimization of the first function, based on whether a broken dependency corresponding to the first or second function exists.

6. The system of claim 1, wherein the scheduler determines whether code generation for a first function and a second function of the plurality of functions are to be performed concurrently, based on a number of dependencies of each of the first function and the second function.

7. The system of claim 1, wherein the dependency analyzer generates a directed acyclic graph based on the dependencies among the plurality of functions.

8. A method for compiling a computer program having a plurality of functions, comprising:
a) performing a dependency analysis based on the plurality of functions;
b) generating code for each of the plurality of functions; and
c) scheduling the code generation for each of the plurality of functions based on the dependency analysis, so that code generation for at least two functions occurs concurrently.

9. The method of claim 8, wherein performing the dependency analysis comprises creating a directed graph and selectively breaking at least one edge of the directed graph based on whether the directed graph includes a cycle that comprises the at least one edge.

10. The method of claim 8, further comprising assembling the generated code for each of the plurality of functions in an order that is deterministically base on the computer program.

11. The method of claim 8, wherein generating the code for each of the plurality of functions comprises performing at least one inter-procedural optimization.

12. The method of claim 8, wherein scheduling the code generation restricts concurrent code generation for a first and second function, wherein the first function has a dependency on the second function.

13. The method of claim 8, wherein scheduling the code generation comprises selectively enabling concurrent code generation for a first function and a second function, based on a reference count for each of the first function and the second function.

14. The method of claim 8, wherein scheduling the code generation comprises selectively enabling concurrent code generation to create an application executable deterministically based on the computer program.

15. A multi-threaded compilation system for compiling a computer program having a plurality of functions, comprising:
a) a dependency analyzer component configured to perform actions including creating a representation of one or more dependencies among the functions of the computer program;
b) code generation means for performing concurrent code generation of at least two functions of the computer program, the code generation including inter-procedural optimization; and
c) scheduling means for managing the code generation means to enable the inter-procedural optimization to be deterministically based on the computer program.

16. The multi-threaded compilation system of claim 15, further comprising assembler means for aggregating output of the code generation means to deterministically create an application executable based on the computer program.

17. The multi-threaded compilation system of claim 15, further comprising an assembler component that aggregates output of the code generation means based on at least one sort key means to deterministically create an application executable based on the computer program.

18. The multi-threaded compilation system of claim 15, wherein:
a) the dependency analyzer component creates a directed graph based on the plurality of functions and selectively breaks one or more dependencies of the directed graph; and
b) each code generator instance is configured to selectively perform inter-procedural optimization based on the one or more broken dependencies.

19. The multi-threaded compilation system of claim 15, wherein the scheduling means schedules code generation for each function based on a number of unsatisfied dependencies corresponding to the function.

20. The multi-threaded compilation system of claim 15, wherein the scheduling means selectively schedules concurrent code generation of a first function and a second function based on at least one of a number of unsatisfied dependencies corresponding to each of the first and second functions or whether a dependency exists between the first and second functions.

21. The multi-threaded compilation system of claim 15, wherein the representation of the one or more dependencies is a directed graph having nodes that represent each of the plurality of functions.
